(19) United States
(12) Patent Application Publication
(10) Pub. No.: US 2022/0205118 A1
(43) Pub. Date: Jun. 30, 2022

(54) WATER SPLITTING CATALYST

(71) Applicants: RESEARCH & BUSINESS FOUNDATION SUNGKYUNKWAN UNIVERSITY, Suwon-si (KR); INSTITUTE FOR BASIC SCIENCE, Daejeon (KR)

(72) Inventors: Hyoyoung LEE, Suwon-si (KR); Jinsun LEE, Suwon-si (KR); Ashwani KUMAR, Suwon-si (KR)

(73) Assignees: RESEARCH & BUSINESS FOUNDATION SUNGKYUNKWAN UNIVERSITY, Suwon-si (KR); INSTITUTE FOR BASIC SCIENCE, Daejeon (KR)

(21) Appl. No.: 17/560,979

(22) Filed: Dec. 23, 2021

(30) Foreign Application Priority Data
Dec. 24, 2020 (KR) 10-2020-0183031

(51) Int. Cl. C25B 11/073; C25B 1/04; C25B 11/054

(52) U.S. Cl. CPC C25B 11/073; C25B 11/054; C25B 1/04

(57) ABSTRACT

The present disclosure relates to a water splitting catalyst including a porous carbon layer, a bimetallic metal alloy core dispersed on the porous carbon layer, and a single-atom precious metal dispersed on the bimetallic metal alloy core, in which oxygen is adsorbed on the surface of the bimetallic metal alloy core.

### CROSS-REFERENCE TO RELATED APPLICATIONS

This application claims the benefit under 35 U.S.C. § 119(a) of Korean Patent Application No. 10-2020-0183031 filed on Dec. 24, 2020, in the Korean Intellectual Property Office, the entire disclosure of which is incorporated herein by reference for all purposes.

### BACKGROUND

### 1. Field

The present disclosure relates to a water splitting catalyst.

### 2. Description of the Related Art

A reaction forming hydrogen and oxygen by splitting water does not generate carbon dioxide, etc., unlike thermal power generation and is gaining attention as an eco-friendly energy source generation method, since it does not generate radioactive waste unlike nuclear power generation. However, an oxygen evolution reaction (OER) in the water splitting reaction consumes a lot of energy or requires a long-time such that it has been an obstacle to commercialization of water electrolysis.

The water splitting reaction has been carried out through a Pt-based cathode and a RuO₂ or IrO₂ anode, but the RuO₂ or IrO₂ anode that produces oxygen requires use of precious metals, so that expensive materials are required, and the possibility of cross-contamination may exist. Although attention has been paid to single-atom catalysts (SACs) in order to reduce the use of expensive precious metals, problems such as easy exfoliation of the single-atom catalysts due to weak interactions between atoms and a support, occurrence of a problem that single atoms are agglomerated with each other, etc., have been occurred.

The paper Z. Pu, I. S. Amiinu, R. Cheng, P. Wang, C. Zhang, S. Mu, W. Zhao, F. Su, G. Zhang, S. Liao, S. Sun, “Single-Atom Catalysts for Electrochemical Hydrogen Evolution Reaction: Recent Advances and Future Perspectives,” Nano-Micro Lett. (2020) 12:21, pp. 1-29, which is a background art of the present disclosure, relates to a single-atom catalyst, which can be used in an electrochemical hydrogen evolution reaction. However, the above-mentioned paper does not disclose a single-atom catalyst, which can be used in the OER.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, the present disclosure provides a water splitting catalyst including a porous carbon layer, a bimetallic metal alloy core dispersed on the porous carbon layer, and a single-atom precious metal dispersed on the bimetallic metal alloy core, in which oxygen is adsorbed on the surface of the bimetallic metal alloy core.

According to an embodiment of the present disclosure, the oxygen adsorbed on the surface of the bimetallic metal alloy core may stabilize an intermediate material of a water splitting reaction, but the present disclosure is not limited thereto.

According to an embodiment of the present disclosure, the water splitting catalyst may further include an additional oxygen disposed on a surface of the porous carbon layer, but the present disclosure is not limited thereto.

According to an embodiment of the present disclosure, the porous carbon layer may include graphene having defects, but the present disclosure is not limited thereto.

According to an embodiment of the present disclosure, two metals included in the bimetallic metal alloy core may have an atomic composition ratio of 0.25:1 to 4:1, but the present disclosure is not limited thereto.

According to an embodiment of the present disclosure, the bimetallic metal alloy core may include two metal elements selected from the group consisting of Fe, Co, Cu, Zn, Ni, Mn, Cr, Ti, Y, Zr, Nb, and Mo, but the present disclosure is not limited thereto.

According to an embodiment of the present disclosure, the precious metal may be selected from the group consisting of Ru, Ir, Rh, Pd, Ag, Au, Pt, and combinations thereof, but the present disclosure is not limited thereto.

According to an embodiment of the present disclosure, the water splitting catalyst may include 0.01 to 0.8 atomic parts of the single-atom precious metal based on 100 atomic parts of the water splitting catalyst.

According to an embodiment of the present disclosure, the water splitting catalyst may include 1 to 7 atomic parts of the oxygen adsorbed on the surface of the bimetallic metal alloy core based on 100 atomic parts of the water splitting catalyst.

According to an embodiment of the present disclosure, the water splitting catalyst may include 1 to 20 atomic parts of the additional oxygen disposed on the surface of the porous carbon layer based on 100 atomic parts of the water splitting catalyst.

According to an embodiment of the present disclosure, the water splitting catalyst may require an overpotential of 100 to 250 mV to achieve a current density of 10 mA/cm².

According to an embodiment of the present disclosure, the water splitting catalyst may have a Tafel slope of 40 to 70 mV/dec.

In another general aspect, the present disclosure provides a method for preparing a water splitting catalyst including forming a mixed solution including a metal-polymer micelle (M₁M₂-micelles) by mixing a first metal precursor, a second metal precursor, and a polymer solution; forming an intermediate, in which a precious metal is disposed on a surface of the metal-polymer micelle by injecting a precious metal precursor into the mixed solution; and heat-treating the intermediate.

According to an embodiment of the present disclosure, the method may further include self-assembling the intermediate before the heat-treating, but the present disclosure is not limited thereto.

According to an embodiment of the present disclosure, the metal-polymer micelle may include a bimetallic metal alloy core including two metal elements and a polymer dispersed on a surface of the bimetallic metal alloy core, but the present disclosure is not limited thereto.

According to an embodiment of the present disclosure, in the heat-treating, the polymer of the intermediate may form a porous carbon layer, but the present disclosure is not limited thereto.

According to an embodiment of the present disclosure, the polymer solution may include a polymer selected from the group consisting of polystyrene (PS), polyethylene glycol (PEG), polypropylene glycol (PPG), polylactic acid (PLA), and combinations thereof, but the present disclosure is not limited thereto.

According to an embodiment of the present disclosure, the polymer solution may have a pH of 8 to 11, but the present disclosure is not limited thereto.

In still another general aspect, the present disclosure provides a water splitting system including the water splitting catalyst according to the first aspect.

According to an embodiment of the present disclosure, the water splitting catalyst may be a catalyst for an oxygen evolution reaction or a hydrogen evolution reaction, but the present disclosure is not limited thereto.

Other features and aspects will be apparent from the following detailed description, the drawings, and the claims.

### BRIEF DESCRIPTION OF THE DRAWINGS

FIG. 1 is a schematic diagram of a water splitting catalyst according to an embodiment of the present disclosure.

FIG. 2 is a flowchart illustrating a method for preparing a water splitting catalyst according to an embodiment of the present disclosure.

FIG. 3 is a schematic diagram showing a method for preparing a water splitting catalyst according to an embodiment of the present disclosure.

FIG. 4 is a schematic diagram of a water splitting system according to an embodiment of the present disclosure.

FIG. 5 is an X-ray diffraction (XRD) graph of a water splitting catalyst according to an example of the present disclosure.

FIGS. 6A to 6C are transmission electron microscope (TEM) images of a water splitting catalyst according to an example of the present disclosure, FIGS. 6D and 6E are high-angle annular dark-field scanning transmission electron microscopy (HAADF-STEM) images, and FIG. 6F is the profiles of the line scan intensities for sites 1 and 2 of FIG. 6E.

FIG. 7 is TEM images of a water splitting catalyst according to an example of the present disclosure.

FIG. 8 is scanning electron microscopy with energy-dispersive X-ray spectroscopy (SEM-EDX) elemental analysis images of a water splitting catalyst according to an example of the present disclosure.

FIGS. 9A to 9C are X-ray photoelectron spectroscopy (XPS) spectra of water splitting catalysts according to an example and a comparative example of the present disclosure.

FIGS. 10A to 10E are XPS spectra of water splitting catalysts according to an example and a comparative example of the present disclosure.

FIGS. 11A to 11C are X-ray absorption near edge structure (XANES) spectra of water splitting catalysts according to an example and a comparative example of the present disclosure.

FIGS. 12A to 12C are extended X-ray absorption fine structure (EXAFS) spectra of water splitting catalysts according to an example and a comparative example of the present disclosure.

FIG. 13 is wavelet transform of extended X-ray absorption fine structure (WT-EXAFS) images of a water splitting catalyst according to an example of the present disclosure.

FIG. 14 is EXAFS fitting curves of water splitting catalysts according to an example and a comparative example of the present disclosure.

FIGS. 15A to 15E are graphs for the oxygen evolution reactions of water splitting catalysts according to an example and a comparative example of the present disclosure.

FIGS. 16A and 16B are graphs showing the water splitting capacities of water splitting catalysts according to an example and a comparative example of the present disclosure.

FIG. 17 is a graph showing the durabilities of water splitting systems according to an example and a comparative example of the present disclosure.

FIG. 18 is a graph showing the durability of a water splitting system according to an example of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF THE EMBODIMENT

Hereinafter, embodiments of the present disclosure will be described in detail with reference to the accompanying drawings so that those with ordinary skill in the art to which the present disclosure pertains will easily be able to implement the present disclosure.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

Throughout the present disclosure, when a part is said to be “connected” with the other part, it not only includes a case that the part is “directly connected” to the other part, but also includes a case that the part is “electrically connected” to the other part with another element being interposed therebetween.

Throughout the present disclosure, when any member is positioned “on”, “over”, “above”, “beneath”, “under”, and “below” the other member, this not only includes a case that the any member is brought into contact with the other member, but also includes a case that another member exists between two members.

Throughout the present disclosure, if a prescribed part “includes” a prescribed element, this means that another element can be further included instead of excluding other elements unless any particularly opposite description exists.

When unique manufacture and material allowable errors of numerical values are suggested to mentioned meanings of terms of degrees used in the present specification such as “about”, “substantially”, etc., the terms of degrees are used in the numerical values or as a meaning near the numerical values, and the terms of degrees are used to prevent that an unscrupulous infringer unfairly uses a disclosure content, in which exact or absolute numerical values are mentioned to help understanding of the present disclosure. Further, in the whole specification of the present disclosure, “a step to do˜” or “a step of˜” does not mean “a step for˜”.

Throughout the present disclosure, a term of “a combination thereof” included in a Markush type expression, which means a mixture or combination of one or more selected from the group consisting of constituent elements described in the Markush type expression, means including one or more selected from the group consisting of the constituent elements.

Throughout the present disclosure, the description of “A and/or B” means “A, B, or A and B”.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” “has,” and “contains” specify the presence of stated features, numbers, operations, members, elements, and/or combinations thereof, but do not preclude the presence or addition of one or more other features, numbers, operations, members, elements, and/or combinations thereof.

Hereinafter, a water splitting catalyst of the present disclosure will be described in detail with reference to embodiments, examples, and drawings. However, the present disclosure is not limited to such embodiments, examples, and drawings.

The present disclosure is to solve the aforementioned problems of the conventional art, and an object of the present disclosure is to provide a water splitting catalyst and a method for preparing the same.

Further, the other object of the present disclosure is to provide a water splitting system including the water splitting catalyst.

As a technical means for achieving the above-mentioned technical tasks, the first aspect of the present disclosure provides a water splitting catalyst including a porous carbon layer, a bimetallic metal alloy core dispersed on the porous carbon layer, and a single-atom precious metal dispersed on the bimetallic metal alloy core, in which oxygen is adsorbed on the surface of the bimetallic metal alloy core.

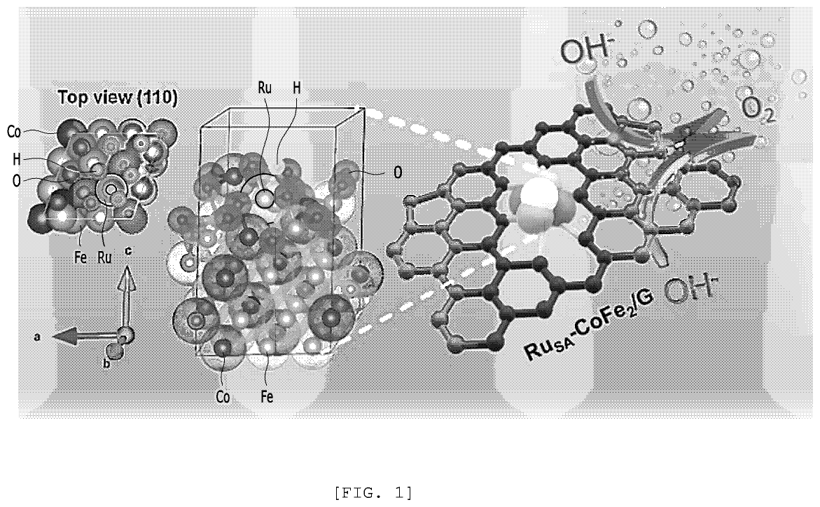

FIG. 1 is a schematic diagram of a water splitting catalyst according to an embodiment of the present disclosure. Specifically, FIG. 1 is about a bimetallic metal alloy core dispersed on a porous carbon layer, and FIG. 1 discloses an alloy core of Fe and Co, which is existed in a state that an Ru single-atom precious metal is dispersed on the surface thereof, and oxygen is adsorbed thereon. However, other precious metals may be used instead of Ru, and metal alloys other than those of Fe and Co may be used.

In general, a water splitting catalyst refers to a catalyst for accelerating a reaction, in which water (H₂O) is split into oxygen (O₂) and hydrogen (H₂). In this regard, the water splitting catalyst according to the present disclosure is for splitting water to form oxygen, and may be used in a reduction electrode in a water splitting system to be described later.

In the present disclosure, single-atom precious metals mean one, in which the precious metal atoms are not agglomerated with each other unlike nanoparticles or the like, and exist in the form of single atoms. Such single-atom precious metals are being studied as novel catalysts as they provide 100% atomic utilization and exhibit superior catalytic activities compared to metal nanoparticles.

A single-atom precious metal according to the present disclosure is one, in which one atom of the precious metal is dispersed in the bimetallic metal alloy core, and may function as a catalyst of an oxygen evolution reaction. In this regard, when the precious metal exists in the form of nanoparticles, that is, in the form of agglomerated single atoms, the water splitting catalyst may also be used as a catalyst for a hydrogen evolution reaction.

According to an embodiment of the present disclosure, oxygen formed on the surface of the bimetallic metal alloy core may stabilize an intermediate material of the water splitting reaction, but the present disclosure is not limited thereto.

Specifically, the water splitting reaction may be divided into an oxygen evolution reaction and a hydrogen evolution reaction, and the oxygen evolution reaction may include a reaction according to the reaction formula below.

[Reaction Formula]

2H₂O→HO^{*}+H₂O+H⁺+e⁻→O^{*}H₂O+2H⁺+2e⁻→HOO^{*}+3H⁺+3e⁻→O₂+4H⁺+4e⁻

Conventional catalysts used in an oxygen evolution reaction could not stabilize the HOO^{*} intermediate, and a large amount of energy was required for the reaction, in which O^{*} became HOO^{*} so that a large amount of energy was required to generate oxygen. However, the water splitting catalyst according to the present disclosure may have better performance than the conventional catalysts for the oxygen evolution reaction by allowing a single-atom precious metal to reduce the kinetic energy barrier of the reaction, in which O^{*} becomes HOO^{*}, and enabling the HOO^{*} intermediate to be stabilized through adsorbed oxygen present on the surface of the catalyst at the same time.

According to an embodiment of the present disclosure, the water splitting catalyst may further include an additional oxygen formed on the surface of the porous carbon layer, but the present disclosure is not limited thereto.

The water splitting catalyst according to the present disclosure may include oxygen (O_{lattice}) adsorbed on the surface of the bimetallic metal alloy core and oxygen (O_{substrate}) formed on the surface of the porous carbon layer.

Oxygen formed on the surface of the porous carbon layer is one, in which the porous carbon layer is doped with a heteroatom, and may improve the water splitting reaction rate by increasing conductivity of the porous carbon layer, thereby increasing mobility of electrons.

According to an embodiment of the present disclosure, the water splitting catalyst may include 0.01 to 0.8 atomic parts of a single-atom precious metal, 1 to 7 atomic parts of oxygen adsorbed on a bimetallic metal alloy core, and 1 to 20 atomic parts of oxygen formed on the surface of the porous carbon layer, with respect to 100 atomic parts of the water splitting catalyst, but the present disclosure is not limited thereto.

As will be described later, in the process of etching the water splitting catalyst, the ratio of oxygen formed on the surface of the porous carbon layer may decrease so that the ratio of oxygen adsorbed on the bimetallic metal alloy core may increase.

According to an embodiment of the present disclosure, the porous carbon layer may contain graphene having defects, but the present disclosure is not limited thereto. At this time, the graphene is one, in which carbons form a two-dimensional planar structure, and may include graphene oxide or reduced-graphene oxide.

According to an embodiment of the present disclosure, the defects may include any one or more point defects of vacancy, interstitial atom, and substitutional atom, but the present disclosure is not limited thereto.

The bimetallic metal alloy core of the water splitting catalyst may be present at a location of defects dispersed on the porous carbon layer, but the present disclosure is not limited thereto.

When the bimetallic metal alloy core is not present at the location of the defects dispersed on the porous carbon layer, the degree of contact between the electrolyte, which is a reaction target of the water splitting reaction, and the active site of the single-atom precious metal is reduced or eliminated so that the water splitting reaction may be limitedly performed.

According to an embodiment of the present disclosure, two metals contained in the bimetallic metal alloy core may have an atomic composition ratio of 0.25:1 to 4:1, but the present disclosure is not limited thereto. For example, the two metals contained in the bimetallic metal alloy core may have an atomic composition ratio of about 0.25 : 1 to 4:1, about 0.5:1 to 4:1, about 0.75:1 to 4:1, about 1:1 to 4:1, about 1.25:1 to 4:1, about 1.5:1 to 4:1, about 1.75:1 to 4:1, about 2:1 to 4:1, about 2.25:1 to 4:1, about 2.5:1 to 4:1, about 2.75:1 to 4:1, about 3:1 to 4:1, about 3.25:1 to 4:1, about 3.5:1 to 4:1, about 3.75:1 to 4:1, about 0.25:1 to 0.5:1, about 0.25:1 to 0.75:1, about 0.25:1 to 1:1, about 0.25:1 to 1.25:1, about 0.25:1 to 1.5:1, about 0.25:1 to 1.75:1, about 0.25:1 to 2:1, about 0.25:1 to 2.25:1, about 0.25:1 to 2.5:1, about 0.25:1 to 2.75:1, about 0.25:1 to 3:1, about 0.25:1 to 3.25:1, about 0.25:1 to 3.5:1, about 0.25:1 to 3.75:1, about 0.5:1 to 3.75:1, about 0.75:1 to 3.5:1, about 1:1 to 3.25:1, about 1.25:1 to 3:1, about 1.5:1 to 2.75:1, about 1.75:1 to 2.5:1, about 2:1 to 2.25:1, or about 0.5:1 to 2:1, but the present disclosure is not limited thereto.

The bimetallic metal alloy core is a support of the single-atom precious metal, and may prevent the single-atom precious metals from bonding to each other, may have oxygen adsorbed on the surface thereof, and may supply electrons necessary for the water splitting reaction or collect generated electrons.

According to an embodiment of the present disclosure, the bimetallic metal alloy core may include two metal elements selected from the group consisting of Fe, Co, Cu, Zn, Ni, Mn, Cr, Ti, Y, Zr, Nb, and Mo, but the present disclosure is not limited thereto. Preferably, the bimetallic metal alloy core may be an alloy of Fe and Co.

According to an embodiment of the present disclosure, the precious metal may include one selected from the group consisting of Ru, Ir, Rh, Pd, Ag, Au, Pt, and combinations thereof, but the present disclosure is not limited thereto.

According to an embodiment of the present disclosure, the water splitting catalyst may require an overpotential of 100 to 250 mV in order to achieve a current density of 10 mA/cm², but the present disclosure is not limited thereto. For example, the water splitting catalyst may require an overpotential of about 100 to 250 mV, about 125 to 250 mV, about 150 to 250 mV, about 175 to 250 mV, about 200 to 250 mV, about 225 to 250 mV, about 100 to 125 mV, about 100 to 150 mV, about 100 to 175 mV, about 100 to 200 mV, about 100 to 225 mV, about 125 to 225 mV, about 150 to 200 mV, or about 175 mV in order to achieve a current density of 10 mA/cm², but the present disclosure is not limited thereto.

At this time, the current density may be an index indicating the performance of the water splitting catalyst.

The conventional water splitting catalyst requires an overpotential of at least 298 mV in order to achieve a current density of 10 mA/cm². However, since a water splitting catalyst according to the present disclosure only requires an overpotential of 180 mV, the power required to produce oxygen may be reduced when the water splitting catalyst according to the present disclosure is used.

According to an embodiment of the present disclosure, the water splitting catalyst may have a Tafel slope of 40 to 70 mV/dec, but the present disclosure is not limited thereto.

Furthermore, the second aspect of the present disclosure provides a method for preparing a water splitting catalyst, the method includes the steps of forming a mixed solution containing a metal-polymer micelle (M₁M₂-micelles) by mixing a first metal precursor, a second metal precursor, and a polymer solution, forming an intermediate, in which a precious metal is formed on the surface of the metal-polymer micelle by injecting a precious metal precursor into the mixed solution, and heat-treating the intermediate.

With respect to the method for preparing a water splitting catalyst according to the second aspect of the present disclosure, detailed descriptions of parts overlapping with the first aspect of the present disclosure have been omitted, but even if the descriptions have been omitted, the contents described in the first aspect of the present disclosure may be equally applied to the second aspect of the present disclosure.

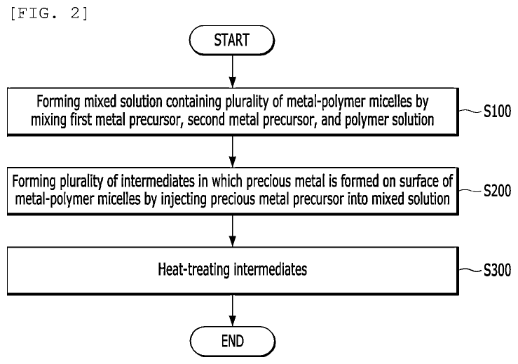

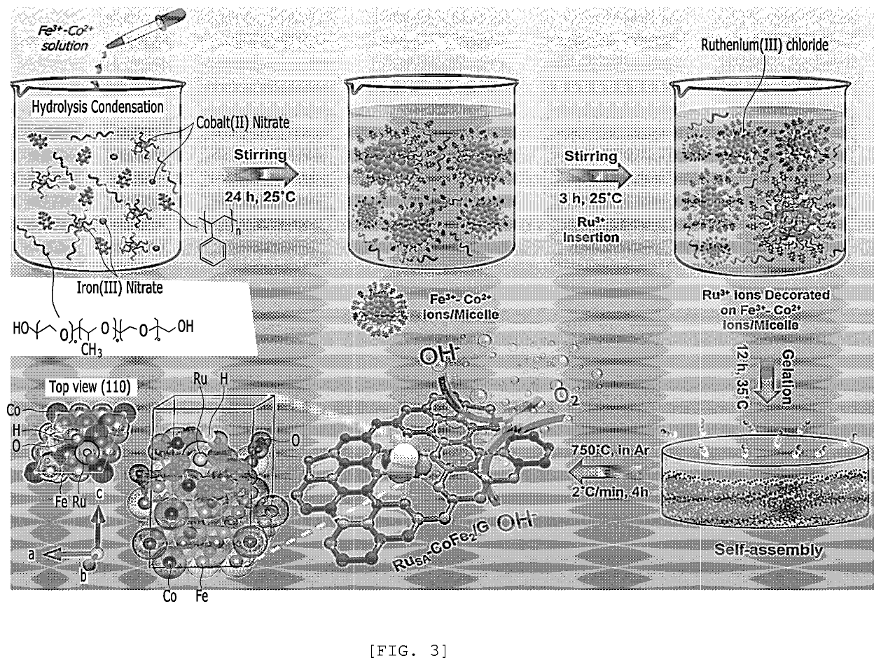

FIG. 2 is a flowchart illustrating a method for preparing a water splitting catalyst according to an embodiment of the present disclosure, and FIG. 3 is a schematic diagram showing a method for preparing a water splitting catalyst according to an embodiment of the present disclosure. Specifically, FIG. 3 means a method for preparing a water splitting catalyst when the first metal and the second metal are Fe and Co, and the precious metal is Ru.

In this regard, the first metal and the second metal refer to two metal elements forming the bimetallic metal alloy core of the water splitting catalyst.

First, a first metal precursor, a second metal precursor, and a polymer solution are mixed to form a mixed solution containing a metal-polymer micelle (M₁M₂-micelles) (S100).

According to an embodiment of the present disclosure, the polymer solution may include a polymer selected from the group consisting of polystyrene (PS), polyethylene glycol (PEG), polylactic acid (PLA), polypropylene glycol (PPG), and combinations thereof, but the present disclosure is not limited thereto. For example, the polymer solution may include F-127 polymer of PEG-PPG-PEG structure and/or PS.

The polymer solution may include an amphiphilic polymer, but the present disclosure is not limited thereto. The amphiphilic polymer may serve as a surfactant in the mixed solution.

According to an embodiment of the present disclosure, the metal-polymer micelle may include a bimetallic metal alloy core including two metal elements and a polymer dispersed on the bimetallic metal alloy core, but the present disclosure is not limited thereto. In this regard, the bimetallic metal alloy core of the metal-polymer micelle may have a form, in which ions of the metal elements or metal particles are agglomerated, unlike the bimetallic metal alloy core of the water splitting catalyst according to the first aspect.

Referring to FIG. 3, the first metal ion and the second metal ion of the first metal precursor and the second metal precursor added to the polymer solution are bonded to each other in the mixed solution so that a bimetallic metal alloy core may be formed. At this time, the amphiphilic polymer of the polymer solution is bonded to the surface of the bimetallic metal alloy core so that the metal-polymer micelle may be formed, in which the hydrophobic region of the polymer is bonded to the bimetallic metal alloy core and the hydrophilic region of the polymer is in contact with a solvent (for example, water) of the mixed solution.

According to an embodiment of the present disclosure, the polymer solution may have a pH of 8 to 11, but the present disclosure is not limited thereto. For example, the polymer solution may have a pH of about 8 to 11, about 8.5 to 11, about 9 to 11, about 9.5 to 11, about 10 to 11, about 10.5 to 11, about 8 to 8.5, about 8 to 9, about 8 to 9.5, about 8 to 10, about 8 to 10.5, about 8.5 to 10.5, about 9 to 10, or about 9.5, but the present disclosure is not limited thereto.

According to an embodiment of the present disclosure, the first metal precursor and the second metal precursor may each independently include a metal element selected from the group consisting of Fe, Co, Cu, Zn, Ni, Mn, Cr, Ti, Y, Zr, Nb, and Mo, and the first metal and the second metal may be different metal elements, but the present disclosure is not limited thereto.

Subsequently, precious metal precursors are injected into the mixed solution to form an intermediate, in which precious metals are formed on the surface of the metal-polymer micelles (S200).

According to an embodiment of the present disclosure, the precious metal precursor may include one selected from the group consisting of Ru, Ir, Rh, Pd, Ag, Au, Pt, and combinations thereof, but the present disclosure is not limited thereto.

The intermediate means one, in which the precious metal is attached in the form of a single atom on the surface of the metal-polymer micelle. At this time, since the metal-polymer micelle is bonded to each Ru atom, the precious metal is not agglomerated in the form of nanoparticles, but is combined with the bimetallic metal alloy core of the metal-polymer micelle so that it may be stabilized in the form of a single atom.

Subsequently, the intermediates are heat-treated (S300).

According to an embodiment of the present disclosure, the method may further include a step of self-assembling the intermediates before heat-treating the intermediates, but the present disclosure is not limited thereto.

Since the intermediates have a form of micelles having precious metals attached to the surface thereof and including a polymer, the intermediates may be self-assembled under specific temperature conditions.

According to an embodiment of the present disclosure, in the step of heat-treating the intermediates, the polymer of the intermediates may form a porous carbon layer, but the present disclosure is not limited thereto.

In this regard, when heat is applied to the polymer composing the intermediates, oxygen of the polymer escapes and the polymer is reduced to a porous carbon layer made of only carbon, and at this time, metal elements or metal particles of the bimetallic metal alloy core of the metal-polymer micelles may be reduced to a metal alloy by the moving electrons.

At this time, oxygen escaped from the polymer may be adsorbed on the surface of the metal alloy.

According to an embodiment of the present disclosure, the porous carbon layer may include a defect, but the present disclosure is not limited thereto.

According to an embodiment of the present disclosure, the bimetallic metal alloy core may be formed at a defect position of the porous carbon layer, but the present disclosure is not limited thereto.

According to an embodiment of the present disclosure, the heat treatment step may be performed in an inert gas atmosphere and at a condition of 600 to 900° C., but the present disclosure is not limited thereto. For example, the heat treatment step may be performed in an inert gas atmosphere and at a condition of about 600 to 900° C., about 650 to 900° C., about 700 to 900° C., about 750 to 900° C., about 800 to 900° C., about 850 to 900° C., about 600 to 650° C., about 600 to 700° C., about 600 to 750° C., about 600 to 800° C., about 600 to 850° C., about 650 to 850° C., about 700 to 800° C., or about 750° C., but the present disclosure is not limited thereto.

According to an embodiment of the present disclosure, the heat treatment step may be performed for 1 to 7 hours, but the present disclosure is not limited thereto. For example, the heat treatment step may be performed for about 1 to 7 hours, about 2 to 7 hours, about 3 to 7 hours, about 4 to 7 hours, about 5 to 7 hours, about 6 to 7 hours, about 1 to 2 hours, about 1 to 3 hours, about 1 to 4 hours, about 1 to 5 hours, about 1 to 6 hours, about 2 to 6 hours, about 3 to 5 hours, or about 4 hours, but the present disclosure is not limited thereto.

When the step of heat-treating the intermediates in an inert gas atmosphere and at a condition of 750° C. is performed for 4 hours, the amount of surface oxygen optimized for the water splitting catalyst may be obtained, and the amount of surface oxygen increases when the time for performing the heat treatment step is reduced to 2 hours or less, and the amount of surface oxygen may be reduced to the minimum when the intermediates are heat-treated together with hydrogen gas.

According to an embodiment of the present disclosure, the method for preparing the water splitting catalyst may further include a step of performing etching with an inert gas before or after performing the heat treatment step, but the present disclosure is not limited thereto.

Furthermore, the third aspect of the present disclosure provides a water splitting system including the water splitting catalyst according to the first aspect.

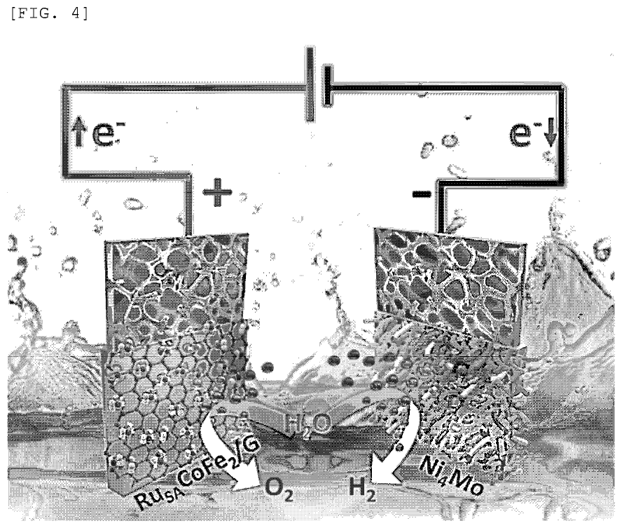

FIG. 4 is a schematic diagram of a water splitting system according to an embodiment of the present disclosure. Specifically, FIG. 4 shows a water splitting system, in which hydrogen is formed at a Ni₄Mo electrode and oxygen is formed at a Ru_{SA}CoFe₂/G electrode, which is a water splitting catalyst according to the present disclosure.

According to an embodiment of the present disclosure, the water splitting catalyst may be a catalyst for an oxygen evolution reaction or a hydrogen evolution reaction, but the present disclosure is not limited thereto.

The water splitting catalyst according to the first aspect includes a bimetallic metal alloy core having a single-atom precious metal formed on the surface thereof, and an oxygen evolution reaction may be promoted by the single-atom precious metal. In this regard, when the precious metal formed on the surface of the bimetallic metal alloy core has the form of nanoparticles, the water splitting catalyst including the precious metal nanoparticles may be used as a catalyst for a hydrogen evolution reaction.

According to an embodiment of the present disclosure, the water splitting system may split basic water or acidic water, but the present disclosure is not limited thereto.

Hereinafter, the present disclosure will be described in more detail through Examples, but the following Examples are for purpose of explanation only and are not intended to limit the scope of the present disclosure.

### EXAMPLE

100 mg of F127 block copolymer and 10 ml of polystyrene (PS) solution (0.5% by weight in ethanol) were dissolved in 20 ml of tetrahydrofuran (THF). Subsequently, 1 M NaOH was slowly dropped into the solution to adjust the pH of the solution to 9 to 10.

Subsequently, a Co precursor and an Fe precursor (in ethanol) were injected into the solution to form a CoFe metal sol. After injecting a Ru precursor into the CoFe metal sol, and slowly evaporating the mixed solution at room temperature to evaporate the THF solvent and the ethanol solvent while performing self-assembling, Ru_{SA}CoFe₂/G, Ru_{SA}Co₂Fe/G, Ru_{NP}CoFe₂/G, Ru_{NP}Co₂Fe/G, etc., were formed by performing a thermal carbon reduction method in an Ar atmosphere at 750° C. for 4 hours (Examples 1 to 5).

At this time, whether Ru becomes a form of a single atom (SA) or a form of nanoparticles (NP) may be determined depending on the mass of the Ru precursor injected.

In this regard, the results of EDX analysis of the formed materials are as shown in Table 1 below.

TABLE 1

| | | EDX | | | | | | |
|---|---|---|---|---|---|---|---|---|
| | | C | Co | Fe | O | Ru | Co:Fe | |
| Classification | Sample | (at. %) | (at. %) | (at. %) | (at. %) | (at. %) | Expt. | Obser. |
| Example 1 | Ru_{SA}CoFe₂/G | 68.81 | 8.63 | 17.55 | 3.7 | 0.41 | 1:2 | 1:2 |
| Example 2 | Ru_{SA}CoFe/G | 75.53 | 9.52 | 10.29 | 4.19 | 0.47 | 1:1 | 1:1.1 |
| Example 3 | Ru_{SA}Co₂Fe/G | 70.23 | 16.24 | 8.88 | 4.4 | 0.44 | 2:1 | 1.8:1 |
| Example 4 | Ru_{NP}CoFe₂/G | 73.06 | 6.68 | 12.88 | 6.55 | 0.83 | 1:2 | 1:1.9 |
| Example 5 | Ru_{NP}Co₂Fe/G | 69.82 | 16.82 | 8.52 | 3.95 | 0.89 | 2:1 | 1.97:1 |

In Table 1 above, Examples 1 to 3 are examples, in which Ru is attached to a Co—Fe metal alloy in the form of a single atom, and Examples 4 and 5 are examples, in which Ru is attached to a Co—Fe metal alloy in the form of nanoparticles.

### Comparative Example 1

In the process of Example 1 above, CoFe/G, Co₂Fe/G, or CoFe₂/G was formed since the process of injecting the Ru precursor was not performed.

### Comparative Example 2

Co(NO₃)₂.6H₂O and Fe(NO₃)₂.9H₂O (Co:Fe=1:2) were dissolved in 40 ml of DI water. Subsequently, DI water containing Co and Fe and 40 ml of an aqueous solution containing 3 mmol of Na₂CO₃ and 21 mmol of NaOH were dropped to 4 mg of a precursor RuCl₃.3H₂O in a beaker containing 80 ml of distilled water until the pH of both solutions became 8.5. After stirring the mixed solution for one day, the solid dark brown precipitate was settled, washed with water and ethanol, and vacuum dried in an oven at 70° C. to prepare a Ru_{SA}CoFe₂-LDH nanosheet.

### Comparative Example 3

As a conventional water splitting catalyst, h-NiSₓ, FeNi/RGO LDH, Ru/CoFe-LDH, Cu@Ni—Fe-LDH, and the like were used.

### Experimental Example 1

The water splitting catalysts according to Examples above were analyzed by an electron microscope, XRD, EDX, and the like.

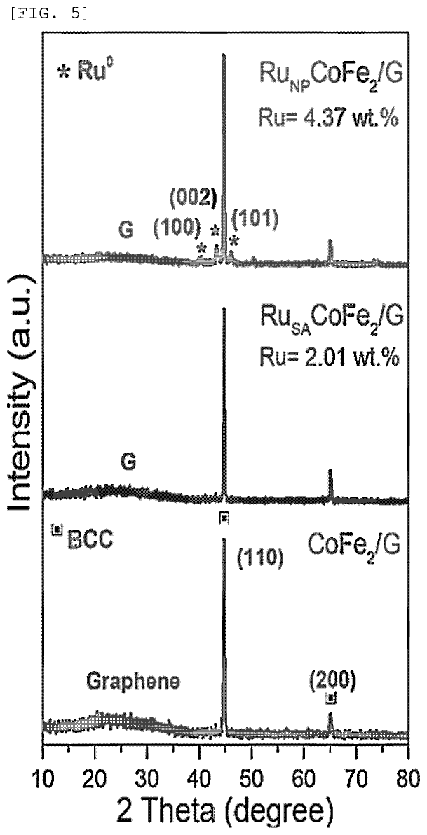

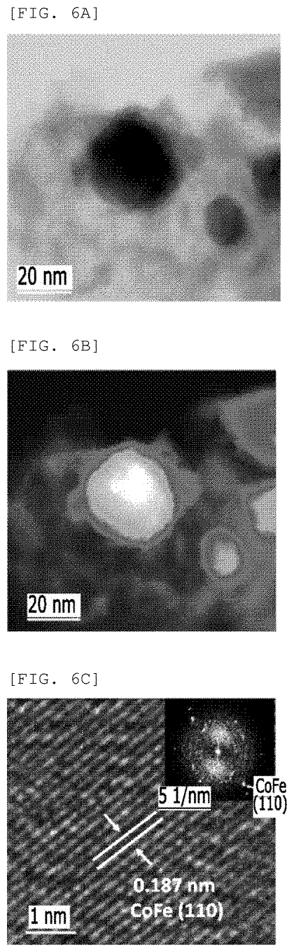

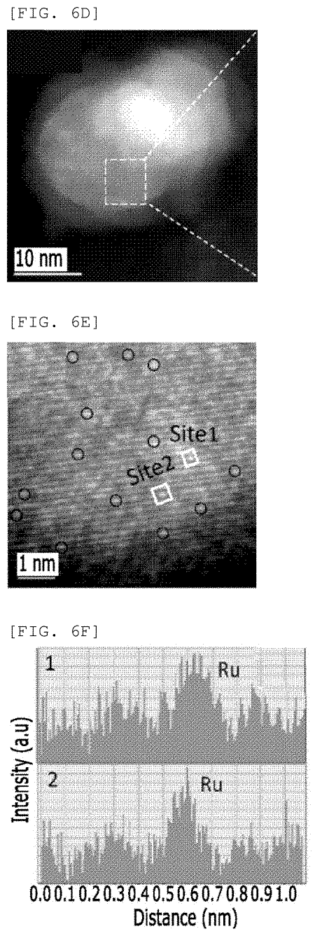

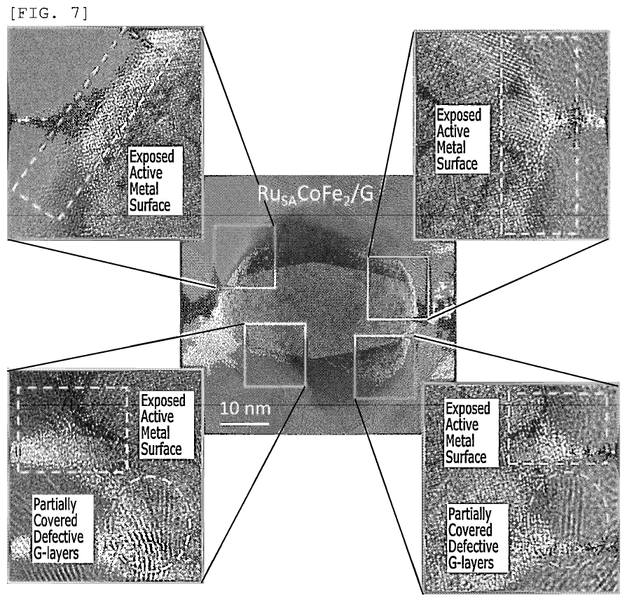

FIG. 5 is an X-ray diffraction (XRD) graph of a water splitting catalyst according to an example of the present disclosure, FIGS. 6A to 6C are transmission electron microscope (TEM) images of a water splitting catalyst according to an example of the present disclosure, FIGS. 6D and 6E are high-angle annular dark-field scanning transmission electron microscopy (HAADF-STEM) images, FIG. 6F is the profiles of the line scan intensities for sites 1 and 2 of FIG. 6E, FIG. 7 is TEM images of a water splitting catalyst according to an example of the present disclosure, and FIG. 8 is scanning electron microscopy with energy-dispersive X-ray spectroscopy (SEM-EDX) elemental analysis images of a water splitting catalyst according to an example of the present disclosure.

Referring to FIGS. 5 to 8, Ru_{SA}CoFe₂/G has an XRD peak similar to that of CoFe₂/G. Further, unlike RuNpCoFe₂/G, since peaks ((100), (002), (101), etc.) by Ru do not appear, and Ru exists in the form of individual dots without being agglomerated on the EDX analysis image, it can be seen from Ru_{SA}CoFe₂/G according to Examples above that Ru is attached to the surface of CoFe₂/G in the form of a single atom.

Further, in Ru_{SA}CoFe₂/G above, the surface of the metal alloy (CoFe₂) is a surface that has been activated by being exposed to the outside, and oxygen may be formed on the surface of Ru_{SA}CoFe₂/G above.

### Experimental Example 2

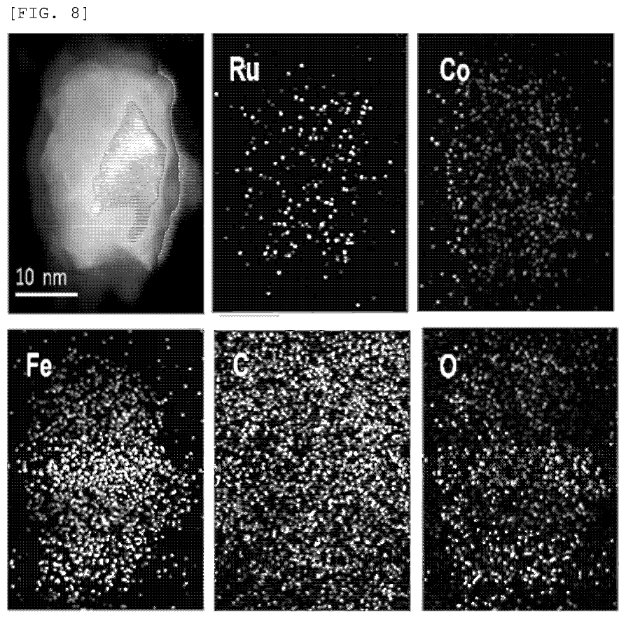

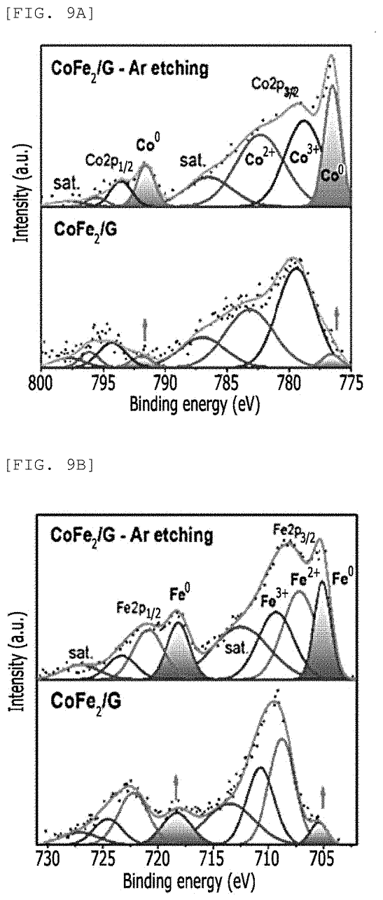

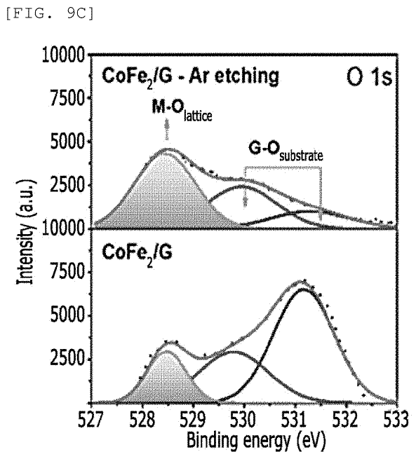

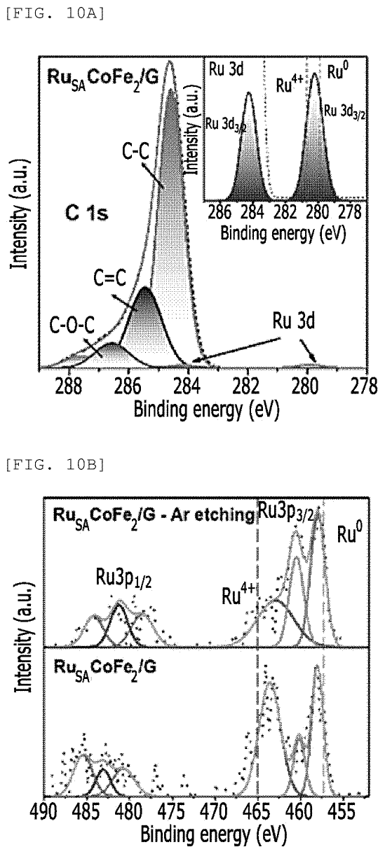

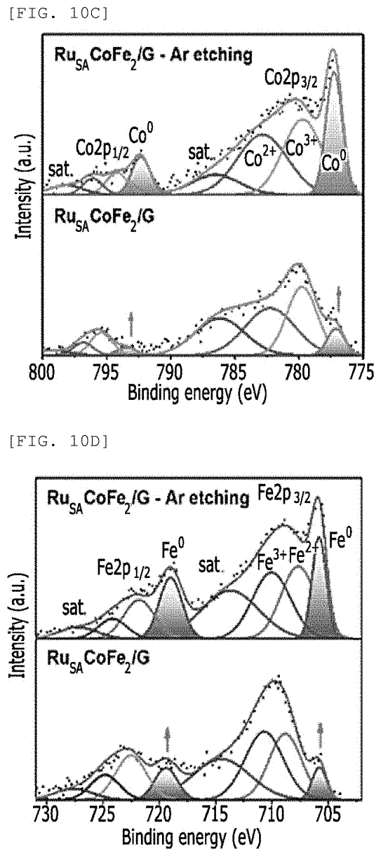

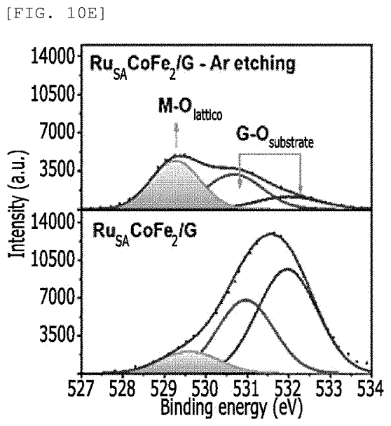

FIGS. 9A to 9C and FIGS. 10A to 10E are X-ray photoelectron spectroscopy (XPS) spectra of water splitting catalysts according to an example and a comparative example of the present disclosure. In this regard, the Ar etching process performed in FIGS. 9A to 9C and 10A to 10E is to confirm whether or not oxygen is present on the surface of the bimetallic metal alloy core (Co—Fe alloy) of the water splitting catalyst.

Referring to FIGS. 9A to 9C and 10A to 10E, it can be confirmed through the Ar etching process that oxygen is present on the surface of the water splitting catalyst by checking that oxygen (O_{substrate}) presenting in the porous carbon layer G is decreased, and oxygen (O_{lattice}) presenting on the surface of the bimetallic metal alloy core (Co—Fe alloy) is increased.

### Experimental Example 3

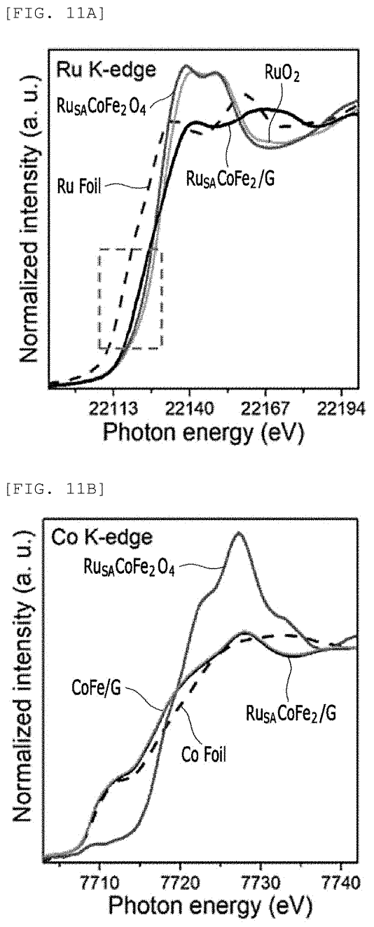

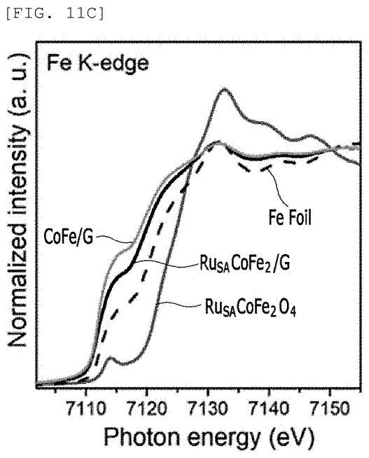

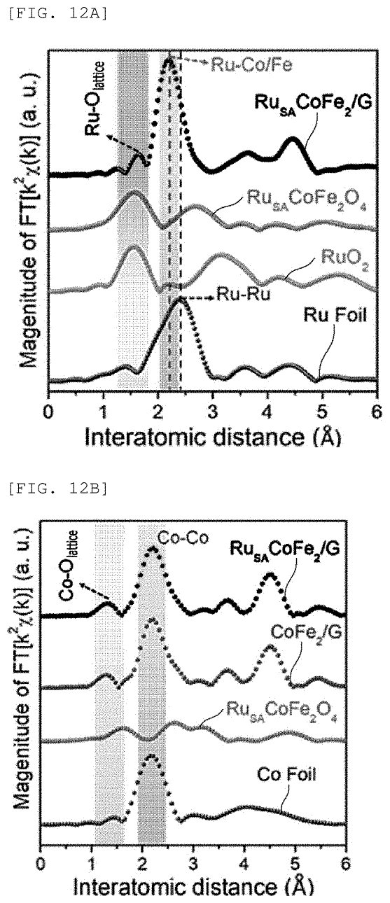

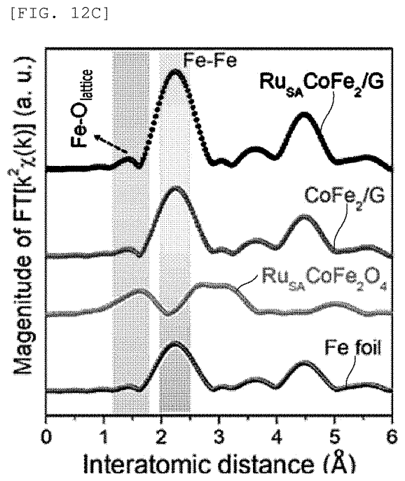

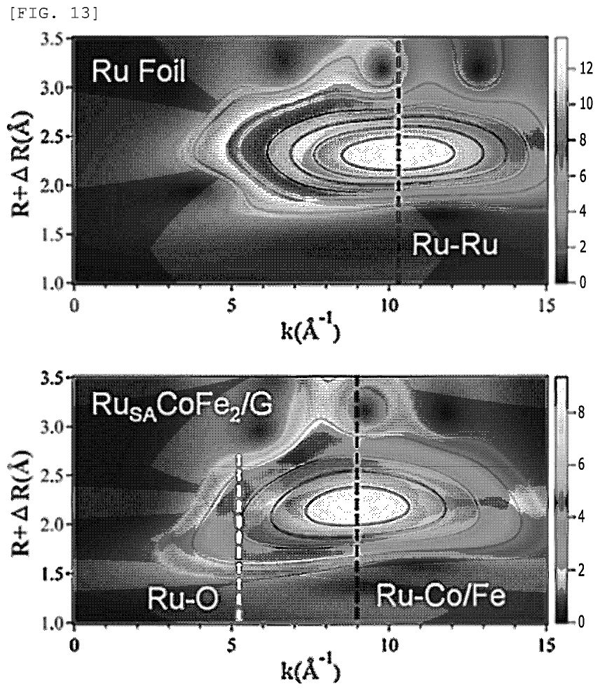

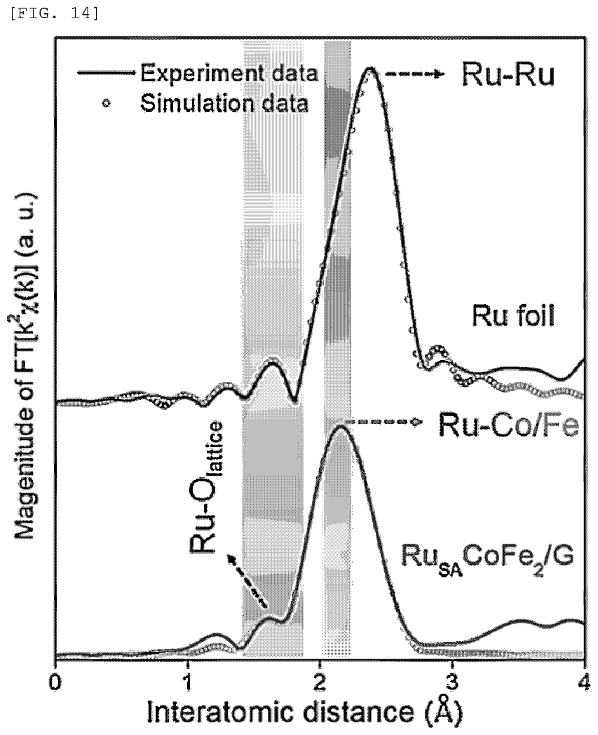

FIGS. 11A to 11C are X-ray absorption near edge structure (XANES) spectra of the water splitting catalysts according to the example and comparative example, FIGS. 12A to 12C are extended X-ray absorption fine structure (EXAFS) spectra of the water splitting catalysts according to the example and comparative example, FIG. 13 is wavelet transform of extended X-ray absorption fine structure (WT-EXAFS) images of the water splitting catalyst according to the example, and FIG. 14 is EXAFS fitting curves of the water splitting catalysts according to the example and comparative example.

Referring to FIGS. 11A to 14, in the water splitting catalyst Ru_{SA}CoFe₂/G according to the example, XANES spectra similar to CoFe/G and a Ru—Co/Fe bond are seen, but a Ru—Ru bond is not confirmed. Therefore, it can be confirmed that the Ru particles of Ru_{SA}CoFe₂/G above exist in the form of single atoms without being agglomerated.

### Experimental Example 4

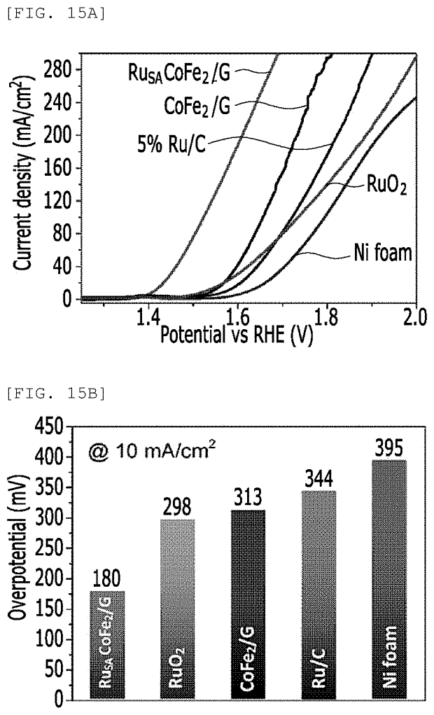

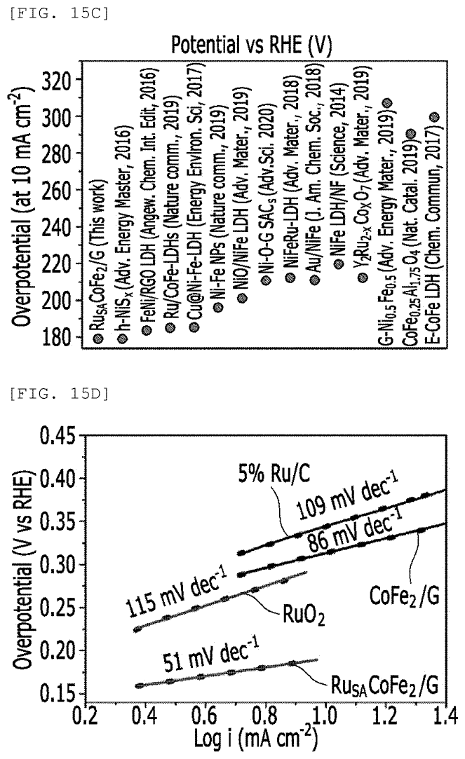

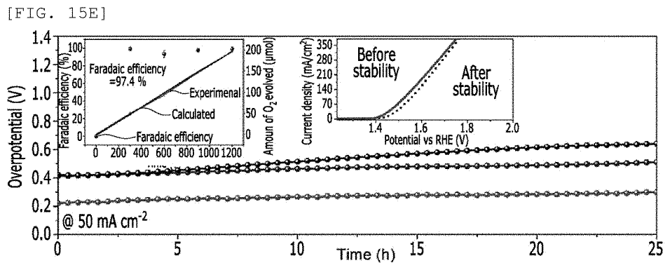

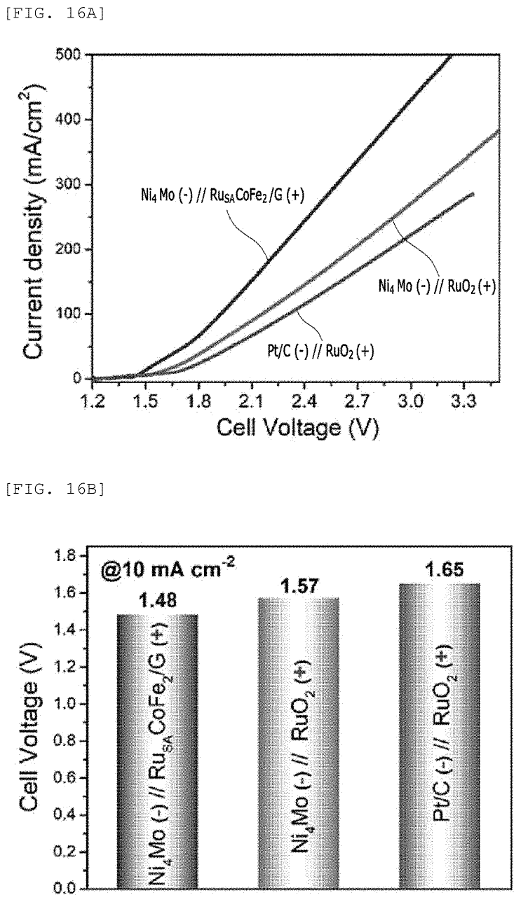

FIGS. 15A to 15E are graphs for the oxygen evolution reactions of the water splitting catalysts according to the example and comparative example. Specifically, FIG. 15A is the OER polarization curves of the water splitting catalysts according to the example and comparative example, FIG. 15B is overpotentials required for the water splitting catalysts according to the example and comparative example to reach 10 mA/cm², FIG. 15C is for the activities of the intrinsic catalysts for OER, FIG. 15D is Tafel plots of the water splitting catalysts according to the example and comparative example, and FIG. 15E is a graph showing the potential differences according to time of the water splitting catalysts according to the example and comparative example in a 1 M KOH electrolyte with a current density of 50 mA/cm² for 25 hours. More specifically, the graph inserted on the left in FIG. 15E is the amount of oxygen gas and Faraday efficiency obtained by the water splitting catalyst according to the example in 1 M KOH, and the graph inserted on the right in FIG. 15E is the LSV curves before and after the stability test.

Referring to FIGS. 15A to 15E, the Ru_{SA}CoFe₂/G can achieve a high current density even at a low voltage compared to other conventional catalysts (RuO₂, CoFe₂/G, 5% Ru/C, or Ni foam), has a low slope of the Tafel curve, and has a low applied voltage even if it is used for a long period of time. Further, the Ru_{SA}CoFe₂/G is stable compared to the conventional catalyst, such as a Faraday efficiency of about 97.4% and the amount of oxygen gas obtained being stable while linearly increasing with time, and it can reduce the electrical energy required for oxygen generation.

### Experimental Example 5

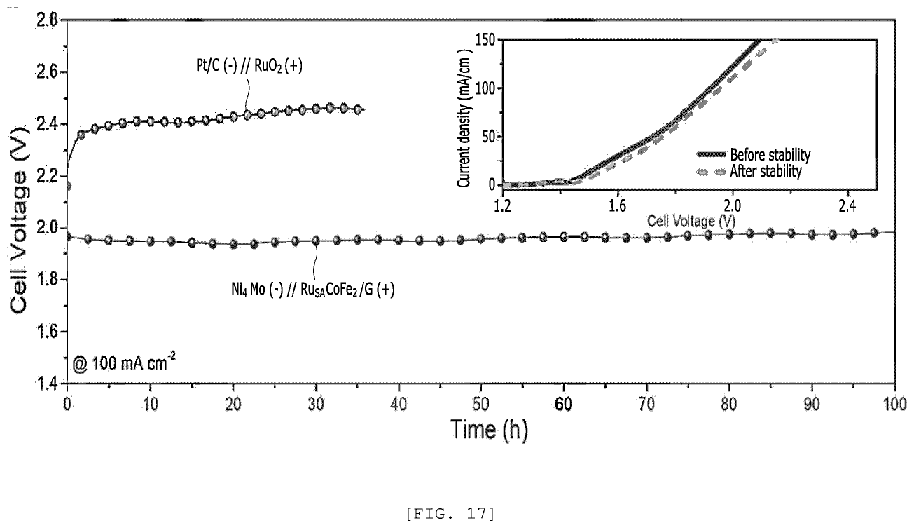

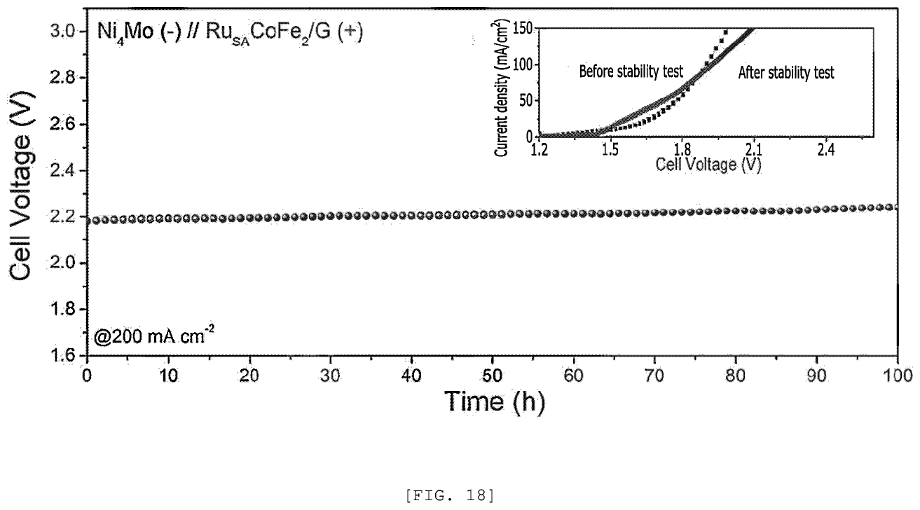

FIGS. 16A and 16B are graphs showing the water splitting capacities of the water splitting catalysts according to the example and comparative example, and FIG. 17 is a graph showing the durabilities of the water splitting systems according to the example and comparative example, and FIG. 18 is a graph showing the durability of the water splitting system according to the example. At this time, the inserted graphs of FIGS. 17 and 18 are the LSV curves before and after the stability test.

Referring to FIGS. 16A to 18, it can be confirmed that the water splitting system including Ni₄Mo//Ru_{SA}CoFe₂/G requires less electrical energy compared to the conventional water splitting system, and has a lifespan of 100 hours, which is more than twice that of the conventional Pt/C//RuO₂ water splitting system.

According to the above-described means for solving the problems of the present disclosure, the water splitting catalyst according to the present disclosure may lower the energy barrier of the rate determining step (the step in which O^{*} becomes HOO^{*} of the oxygen evolution reaction through a single-atom precious metal, and may stabilize HOO^{*} intermediates through oxygen adsorbed on the surface. Accordingly, the water splitting catalyst may produce oxygen by using less energy than a conventional catalyst for an oxygen evolution reaction.

Further, a water splitting catalyst according to the present disclosure may be able to be used also in a hydrogen evolution reaction by changing a single-atom precious metal into a nanoparticle precious metal.

Further, a water splitting catalyst according to the present disclosure may be excellent in durability and oxygen evolution efficiency since there is not a change in the voltage of a battery even when using the water splitting catalyst according to the present disclosure for 100 hours or more, and more oxygen can be formed compared to a conventional water splitting catalyst when the same voltage is applied.

Further, a method for preparing a water splitting catalyst according to the present disclosure may prepare a water splitting catalyst in an inexpensive manner since the use amount of a precious metal is less than that of a conventional method for preparing a water splitting catalyst.

However, the effects obtainable from the present disclosure are not limited to the above-described effects, and other effects may exist.

The foregoing description of the present disclosure is for illustration, and those with ordinary skill in the art to which the present disclosure pertains will understand that it can be easily modified into other specific forms without changing the technical spirit or essential features of the present disclosure. Therefore, it should be understood that the embodiments described above are illustrative in all aspects and not restrictive. For example, each constituent element described as a single type may be implemented in a distributed manner, and likewise constituent elements described as distributed may also be implemented in a combined form.

The scope of the present disclosure is indicated by the claims to be described later rather than the above-detailed description, and all changed or modified forms derived from the meaning and scope of the claims and equivalent concepts thereof should be construed as being included in the scope of the present disclosure.

1. A water splitting catalyst comprising:
a porous carbon layer;
a bimetallic metal alloy core dispersed on the porous carbon layer; and
a single-atom precious metal dispersed on the bimetallic metal alloy core, wherein oxygen is adsorbed on a surface of the bimetallic metal alloy core.

2. The water splitting catalyst of claim 1, wherein the oxygen stabilizes an intermediate material of a water splitting reaction.

3. The water splitting catalyst of claim 1, further comprising additional oxygen disposed on a surface of the porous carbon layer.

4. The water splitting catalyst of claim 1, wherein the porous carbon layer comprises graphene having defects.

5. The water splitting catalyst of claim 1, wherein the bimetallic metal alloy core comprises two metals and an atomic composition ratio of the two metals is 0.25:1 to 4:1.

6. The water splitting catalyst of claim 1, wherein the bimetallic metal alloy core comprises two metal elements selected from the group consisting of Fe, Co, Cu, Zn, Ni, Mn, Cr, Ti, Y, Zr, Nb, and Mo.

7. The water splitting catalyst of claim 1, wherein the single-atom precious metal is selected from the group consisting of Ru, Ir, Rh, Pd, Ag, Au, Pt, and any combination of any two or more thereof.

8. The water splitting catalyst of claim 1, wherein the water splitting catalyst further comprises 0.01 to 0.8 atomic parts of the single-atom precious metal based on 100 atomic parts of the water splitting catalyst.

9. The water splitting catalyst of claim 1, wherein the water splitting catalyst further comprises 1 to 7 atomic parts of the oxygen adsorbed on the surface of the bimetallic metal alloy core based on 100 atomic parts of the water splitting catalyst.

10. The water splitting catalyst of claim 3, wherein the water splitting catalyst further comprises 1 to 20 atomic parts of the additional oxygen disposed on the surface of the porous carbon layer based on 100 atomic parts of the water splitting catalyst.

11. The water splitting catalyst of claim 1, wherein the water splitting catalyst requires an overpotential of 100 to 250 mV to achieve a current density of 10 mA/cm².

12. The water splitting catalyst of claim 1, wherein the water splitting catalyst has a Tafel slope of 40 to 70 mV/dec.

13. A method for preparing a water splitting catalyst, the method comprising:
forming a mixed solution comprising a metal-polymer micelle (M₁M₂-micelle) by mixing a first metal precursor, a second metal precursor, and a polymer solution;
forming an intermediate in which a precious metal is disposed on a surface of the metal-polymer micelle by injecting a precious metal precursor into the mixed solution; and
heat-treating the intermediate.

14. The method of claim 13, further comprising self-assembling the intermediate before the heat-treating.

15. The method of claim 13, wherein the metal-polymer micelle comprises a bimetallic metal alloy core comprising two metal elements and a polymer dispersed on a surface of the bimetallic metal alloy core.

16. The method of claim 13, wherein in the heat-treating, the polymer of the intermediate forms a porous carbon layer.

17. The method of claim 13, wherein the polymer solution comprises a polymer selected from the group consisting of polystyrene (PS), polyethylene glycol (PEG), polypropylene glycol (PPG), polylactic acid (PLA), and any combination of any two or more thereof.

18. The method of claim 13, wherein the polymer solution has a pH of 8 to 11.

19. A water splitting system comprising the water splitting catalyst according to claim 1.

20. The water splitting system of claim 19, wherein the water splitting catalyst is a catalyst for an oxygen evolution reaction or a hydrogen evolution reaction.
